(19) United States
(12) Patent Application Publication
(10) Pub. No.: US 2023/0084560 A1
(43) Pub. Date: Mar. 16, 2023

(54) DISTRIBUTED LIDAR WITH SHARED LIGHT EMITTER

(71) Applicant: James Thomas O'Keeffe, Mountain View, CA (US)

(72) Inventor: James Thomas O'Keeffe, Mountain View, CA (US)

(21) Appl. No.: 17/943,059

(22) Filed: Sep. 12, 2022

Related U.S. Application Data
(60) Provisional application No. 63/243,186, filed on Sep. 12, 2021.
(60) Provisional application No. 63/355,650, filed on Jun. 26, 2022.

(51) Int. Cl. G01S 17/894

(52) U.S. Cl. CPC G01S 17/894

(57) ABSTRACT

LIDARs are often placed at the perimeter of a vehicle to detect objects close to the vehicle (e.g. pedestrians walking close to the vehicle bumper). An ongoing challenge is the interaction of these LIDARs with one another, specifically the interaction of their respective light emitters (e.g. Lasers). In one embodiment a perimeter LIDAR system comprises a ranging subassembly, a plurality of LIDARs and a shared light emitter, each mounted separate from one another on a vehicle. The ranging subassembly is configured to transmit an emitter time reference signal to the shared light emitter and transmits a detector time reference signal to each of the plurality of LIDARs, wherein these time reference signals are generated from a common clock signal. Each of the plurality of LIDARs is configured to receive light reflections from the share light emitter and to use the detector time reference signal to generate a set of time of flight signal. The ranging subassembly is further configured to receive the set of TOF signals from each LIDAR and use location estimates of the share light emitter relative to each of the LIDARs to generate a set of 3D locations using the sets of TOF signals.

### BACKGROUND

Light detection and ranging (LIDAR) is increasingly useful for providing range measurements in the vicinity of autonomous vehicles, robots and smart buildings. Traditionally, LIDAR systems have been placed on the exterior of host platforms (e.g. vehicles) with direct access to a field of view (FOV). While this is useful during research and development, external LIDAR placement with a single FOV poses challenges including aesthetics, long-term reliability and cost.

Flash LIDAR or time-of-flight (TOF) cameras are a class of scannerless LIDAR in which a laser or LED source illuminates a plurality of directions at once and a photodetector array such as a focal plane array (FPA) of avalanche photodiodes, or an array of single photon avalanche detectors (SPADS) detects the timing of reflections from the plurality of directions. An ongoing challenge is that the photodetector array (e.g. single photon avalanche detector) can be the most expensive part of a flash LIDAR. Providing the LIDAR with an unobstructed view of the vicinity typically requires mounting the LIDAR on the exterior of the host platform, where it is subject to weather and damage

In a related area, an ongoing challenge for autonomous vehicles (AVs) and advanced driverless assistance systems (ADAS) is to sense objects in close proximity to the vehicle. This capability is important because many driving scenarios require knowledge of what is going on close to the vehicle (e.g. entering a tight parking spot). Centrally mounting a LIDAR on the roof can provide 360 coverage beyond a certain distance (e.g. beyond 3 meters from a car). However within this distance a centrally located LIDAR may not be able to detect objects due to obstruction by the vehicles roof. To address this challenge some AV platforms have added additional LIDARs to the perimeter of the vehicle (e.g. located the perimeter of the roof or located on the vehicle fenders) in order to detect objects close to the vehicle (e.g. curbs, or pedestrians). In a related aspect, a single perimeter LIDAR may only address a single blindspot and therefore several perimeter LIDARs may be required to address all blindspots. U.S. Patent Application 2015/0192677 to Yu addresses this challenge by disclosing multiple LIDAR sensor around a vehicle to provide adequate coverage. However the operation of multiple LIDARs around a vehicle perimeter in a system remains a significant challenge.

### SUMMARY

Within examples, a distributed LIDAR system is disclosed, comprising a ranging subassembly, one or more LIDARs, and a plurality of shared light emitters. The LIDARs are located remotely from one another, for example, around the perimeter of a car. The shared light emitters can be located remote from the LIDARs and provide light pulses to several of the LIDARs. In prior art, each LIDAR would directly control one or more dedicated light emitters (e.g. a laser, a laser array or an LED). This prior art configuration would enable the LIDAR to closely control the timing of the dedicated light emitter(s) for the purpose of determining the time of flight (TOF) of light pulses. While bistatic LIDARs have been disclosed, whereby the light emitter is located remotely from the light detector, this architecture still requires the light emitter to be directly controlled by a single LIDAR. This is opposite to a light emitter that services several LIDARs at once (i.e. a shared light emitter).

In one aspect of several embodiments the light emitters are shared among multiple LIDARs by passing a common reference timing signal (or a set of distinct reference signals derived from a common clock signal) to both the emitter(s) and the LIDAR(s). A ranging subassembly or central controller in a vehicle can pass the common reference signal to the emitter(s) and the LIDAR(s) In this way a LIDAR can calculate the TOF of a light reflection based on the common (or related) reference timing signal.

Aspects of this disclosure provide solutions for challenges of implementing this architecture. These challenges include crosstalk among multiple emitter (e.g. how to figure out which of the shared emitters a light reflection is arriving from), as well as how to proliferate a common (or related) time reference signal both the emitters and the LIDARs in a distributed architecture.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

Embodiments of the present disclosure are operable to provide the following exemplary advantages: In one advantage the disclosed perimeter detection system enables a single LIDAR to receive reflections from multiple light emitters located on a host vehicle. For example, a LIDAR mounted on the center of a vehicle grille could benefit from two light emitters, one in the left headlight and one in the right headlight. Each of the shared emitters can be positioned to illuminate distinct portions of the FOV of the LIDAR.

In a second advantage, the two light emitters of the previous example could be shared with two other LIDARs mounted on each of the fenders. In this was the present disclosure provides distinct advantage over previous architectures where the 3 LIDARS (Grille and 2 fenders) would have to operate their respective dedicated light emitters in a non-interfering (e.g. time multiplexed) manner. This advantage is achieved by providing a common time reference signal to each of the LIDARs that see reflections from a shared emitter. For example, each of the 3 LIDARs and the shared emitter could receive a common timing pulse to indicate when a laser shot has been emitted by a light emitter.

In a third advantage, the light reflections from a shared light emitter represent usable reflections to any LIDAR that received the common time reference signal. This makes the disclosed architecture more scalable than architectures where multiple LIDARs independently operate dedicated light emitters.

Several embodiments enable the time reference signal to be transmitted to the LIDAR on a simple coax cable thereby simplifying deployment.

The disclosed architecture enables various shared emitters to be specialized (e.g. some with narrow beam angle and high intensity, some with wide field of view, and others aimed at knows areas of interest).

Embodiments of the disclosed architecture enable each LIDAR to provide reflections signals when sequentially illuminated by each of the specialized emitters (e.g. one set of reflections from the left headlight emitter and one set of reflections from the right headlight emitter). The LIDAR or circuitry in the ranging subassembly can thereby process the various sets of reflections to produce a composite 3D pointcloud from multiple shared emitters.

Another advantage of shared light emitters, located remote from the LIDARs is that the emitters can be housed in locations best suited for such emitters (e.g. in headlights and accent lights) while the LIDARs can be located in locations best suited to maximize FOV such as the front grille, side mirrors, behind windshields, or on the perimeter of the roof.

In another advantage, the set of shared emitters can be tailored for different environments or driving scenarios. For example, light emitters with a wide beam angle may be used for parking while light emitters with intense narrow beams may be used for highway driving.

In another advantage, a light emitter co-located with a LIDAR may experience shadowing of a large portion of the FOV by an object. A plurality of shared emitters offers multiple ways to illuminate a scene or an object and provide reflections in the presence of the shadowing object.

### DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 illustrates a distributed LIDAR system with shared light emitters according to an embodiment of the present disclosure.

FIG. 2 illustrates a prior art embodiment of a multi-LIDAR system.

FIG. 3 illustrates a distributed LIDAR system with a shared light emitter according to an embodiment of the present disclosure.

FIG. 4 illustrates a remote ranging subassembly according to an embodiment of the present disclosure.

FIG. 5 illustrates a LIDAR in a distributed ranging system according to an embodiment of the present disclosure.

FIG. 6 illustrates a shared emitter in a distributed ranging system according to an embodiment of the present disclosure.

FIG. 7 is a timing diagram illustrating a method for operating a distributed LIDAR system with shared emitters.

FIG. 8a illustrates a 3D location sensing system with a shared emitter according to an embodiment of the present disclosure.

FIG. 8b illustrates a 3D location sensing system with a shared emitter according to an embodiment of the present disclosure.

FIG. 9 illustrates a LIDAR with an external illuminator in accordance with an embodiment of the current disclosure.

FIG. 10 illustrates a camera stepping through a sequence od focus positions in accordance with an embodiment of the current disclosure.

FIG. 11 illustrates two vehicles each with a LIDAR in accordance with an embodiment of the current disclosure.

FIG. 12 is a timing diagram of illumination pulses from two LIDARs in accordance with an embodiment of the current disclosure.

FIG. 13 is a diagram of a combined camera and LIDAR in accordance with an embodiment of the current disclosure.

FIG. 14 is a diagram of a combined camera and LIDAR in accordance with an embodiment of the current disclosure.

### DETAILED DESCRIPTION

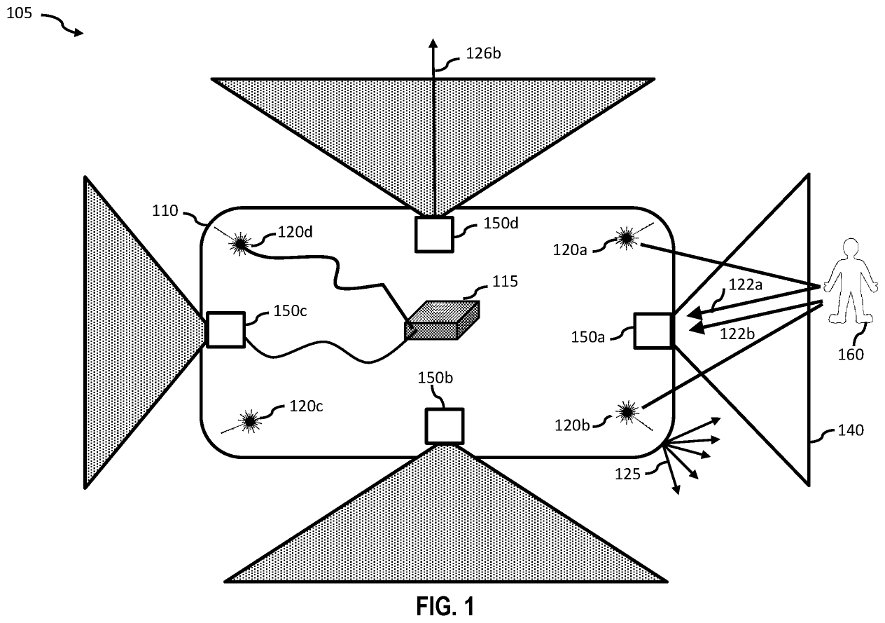

FIG. 1 illustrates a distributed LIDAR system 105 according to an embodiment of the present disclosure. The distributed LIDAR system 105 is illustrated deployed on a vehicle 110, such as a self-driving car. Distributed LIDAR system 105 comprises a remote ranging subassembly 115 that can be located remote from the vehicle perimeter in a location such as the trunk, in the engine bay or in the passenger compartment. Remote ranging subassembly 115 functions to operate four shared light emitters 120a, 120b, 120c and 120d and gather reflection timing data (time of flight data) from four LIDARs 150a, 150b, 150c, 150d located around the perimeter of the vehicle. The placement of these LIDARs is selected to provide visibility to the perimeter of the vehicle and thereby detect objects in close proximity to the vehicle. For example, LIDAR 150a is located in the center of the vehicle grille which provides a FOV 140. LIDAR 150a is positioned to receive light reflections 122a from light emitter 120a in the left headlight assembly as well as receive light reflection 122b from light emitter 120b in the right headlight assembly. Importantly, LIDAR 150d is positioned on the left fender of vehicle 110 and can also receive light reflections from light emitter 120a. Similarly, LIDAR 150b is positioned on the right (passenger side) fender and can receive light reflections from light emitter 120b. Hence the light emitters in FIG. 1 are each positioned to provide light reflections (i.e. be shared) by two LIDARs. Light emitters can be laser emitters or LED emitters. Light emitters can generate a continuous, sporadic or periodic waveform (e.g. a square wave or sinusoidal wave). This is common in phase based time of flight LIDAR architectures where the phase of the reflected light from the light emitters is compared to a reference waveform at the LIDAR. Alternatively light emitters can generate discrete pulses of light and the LIDAR can perform time to digital conversion (TDC). In either case a LIDAR can utilize reflected light from a shared emitter only if it knows when the light was emitted.

Remote ranging subassembly further functions to distribute emitter reference timing signals to a four shared light emitters 120a, 120b, 120c and 120d as well as detector reference timing signals to the four LIDARS 150a, 150b, 150c and 150d. The emitter reference signal functions to tell the shared emitter when to emit light. The detector time reference signals function to indicate to the LIDAR when the shared emitters emitted the light. Each light emitter is operable to emit light rays 125 in a range of directions. Each of the LIDARs is operable to detect light reflections in a FOV, e.g. FOV 140 for LIDAR 150a.

In the embodiment of FIG. 1 ranging subassembly 115 can first command LEFT light emitter 120a to generate a first flash event (e.g. a series of laser pulses or a 20 ms periodically modulated light wave). During this first flash event ranging subassembly 115 can transmit a detector time reference signal to LIDAR 150a. The detector time reference is so named because it enables the LIDAR to recover the time of flight associated with a detected light reflection. Subsequently ranging subassembly 115 can command RIGHT light emitter 120b to generate a second flash event. LIDAR 150a can gather reflections resulting from both flash events. The detector time reference signal sent to the LIDAR 150a in each case enables LIDAR 150a to calculate a measure of the time of flight for each of the set of light reflections. Importantly, the received reflection signals may be much stronger for a particular light emitter in a particular portion of the FOV that each emitter is adapted to. The LIDAR can transmit a set of timing data (time of flight data) corresponding to each flash event to the central controller. The ranging subassembly can combine the timing data from the first and second flash events and generate a set of 3-D locations representing the calculated distances to the reflection coefficients.

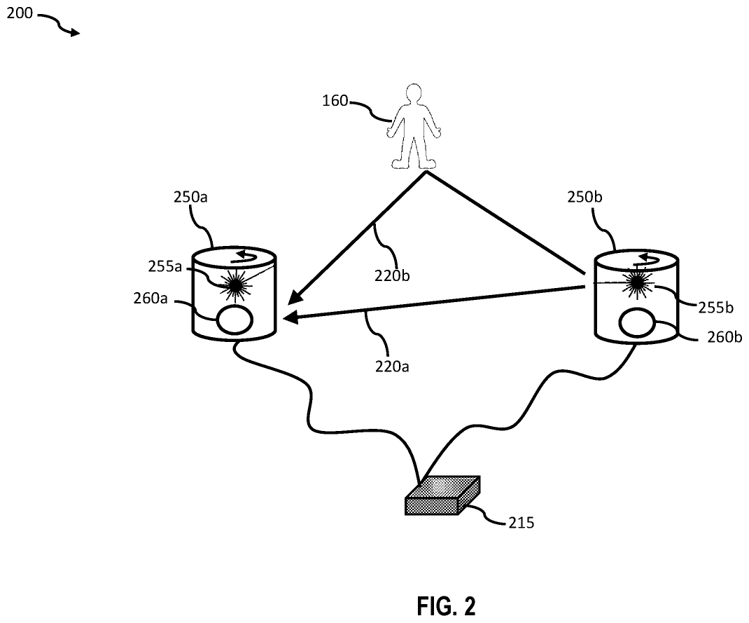

FIG. 2 illustrates a prior embodiment of a multi-LIDAR system for the purpose of highlighting the differences with the present disclosure. The prior art embodiment of FIG. 2 comprises two LIDARs 250a and 250b coupled to a hub 215. Each of the LIDARs comprises a dedicated light emitter (255a and 255b) housed within the LIDAR. Each LIDAR further comprises an detector 260a and 260b to detect reflections from the dedicated light emitter. Both LIDARs are coupled to a hub 215 and transmit time-of-flight data corresponding to a set of light pulses from their respective dedicated emitters. From the perspective of LIDAR 250a on the left, direct light ray 220a from LIDAR 250b constitutes a spurious light source. LIDAR 250a does not receive a timing reference for direct light ray 220a from LIDAR 250b and hence does not have a basis in time to calculate the time-of-flight of ray 220a. Similarly for indirect light ray 220b that is emitted from the right most LIDAR 250b and reflected from person 160, LIDAR 250a lacks a reference time signal to utilize this light reflection. In a related problem, light rays 220a and 220b may saturate detector 260a in a portion of the FOV. In the example of FIG. 2 each LIDAR generates a local timing reference signal for the co-located light emitters 220a and 255a and 255b. This timing reference signal may be in the form of several pulses that trigger laser pulses in the emitters. This timing reference signal may also be a continuous reference signal (e.g. a square or sinusoidal wave). In this case the phase of the continuous wave may serve as the reference feature to instruct the detector in the LIDAR how to time reference received reflections. A key shortcoming of the embodiment of FIG. 2 is that the timing reference signals are generated locally to each LIDAR 250a and 250b and are generate independent of one another.

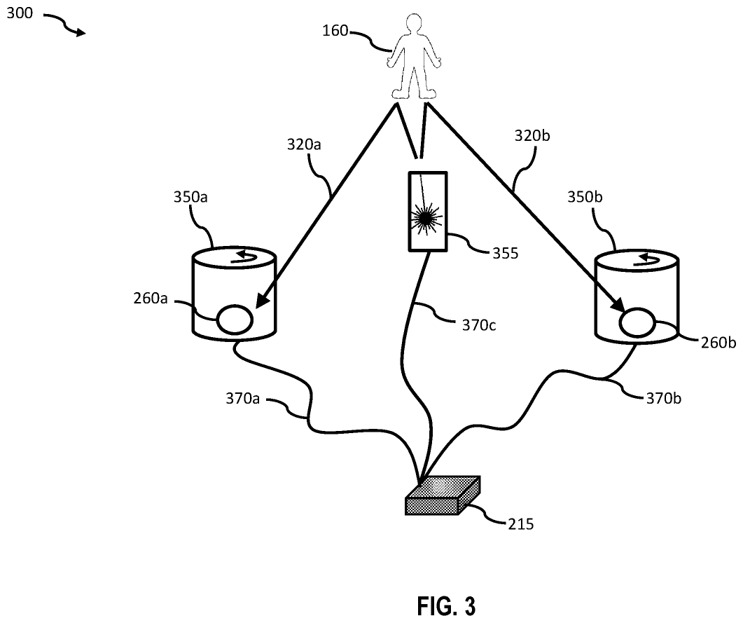

FIG. 3 illustrates an embodiment of a two LIDAR system 300, utilizing a shared light emitter 355, according to an embodiment of the present disclosure. In the embodiment of FIG. 3 an emitter time reference signal is sent to the shared light emitter 355 over connection 370c. Connection 370c can be a coaxial cable, a high speed cable or a wireless radio frequency link or optical link that functions to transfer the emitter time reference signal from the ranging subassembly 215 to the shared light emitter 355. Power can also be carried over connection 370c. Two LIDARs 350a and 350b have photodetectors 260a and 260b respectively and are connected to the ranging subassembly by cables 370a and 370b. In the embodiment of FIG. 3 the shared light emitter 355 is located separate from each of the LIDARS 350a and 350b. A detector time reference signals function to provide a time reference for detected light reflections 320a and 320b from shared light emitter 355. In alternative embodiments, a shared light emitter could be housed inside a first LIDARs and still function as a shared light emitter for other LIDARs located outside and away from the first LIDAR. Ranging subassembly 215 sends detector time reference signals to LIDARs 350a and 350b.

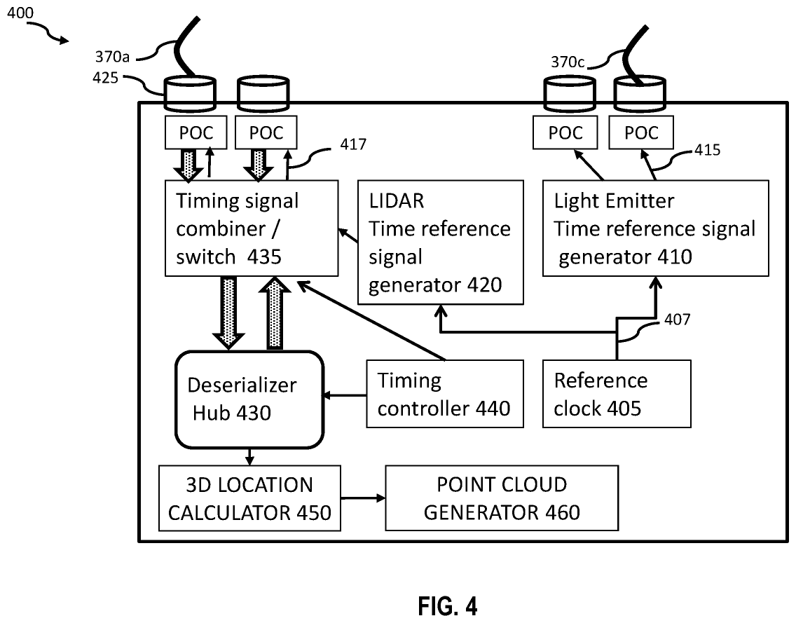

FIG. 4 illustrates a ranging subassembly 400 according to an embodiment of the present disclosure. Ranging subassembly 400 functions to distribute the emitter and detector time reference signals to the shared emitter and LIDARs respectively and to gather sets of time-of-flight signals from the LIDARs corresponding to detected light reflections. In one aspect it is beneficial to use the same cable (e.g. 370a and 370b in FIG. 3) to transfer the detector time reference signals to the LIDARs as well as receive the time of flight data sets from the LIDARs. To accomplish this ranging subassembly 400 has circuitry that functions to time multiplex the cable 370a between transferring time of flight data from the LIDAR to the ranging subassembly and transmitting the detector time reference signal from the ranging subassembly 400 to the LIDAR (e.g. 350a in FIG. 3). Ranging subassembly 400 can further function to gather sets of time-of-flight data from several LIDARs, and process the time of flight data using knowledge of the location of a shared light emitter relative to each LIDAR to determine a set of 3-D locations corresponding to the reflection locations of light from the shared emitter.

Ranging subassembly 400 comprises a reference clock 405 that functions to create a clock signal 407 that forms the basis for both the emitter and detector time reference signals. The clock signal 407 is bed to a Light emitter time reference signal generator 410 and a LIDAR time reference signal generator 420. The time reference signal generators can comprise circuitry to amplify, frequency multiply or frequency divide the clock signal 407. For example, an exemplary clock signal may be 40 Mhz. A LIDAR may have a time-of-flight chip that requires an 8 Mhz clock signal. A design may require a light emitter to modulate at 20 Mhz. In this example the clock signal 407 may be divided by 2 to generate emitter time reference signal 415. Emitter time reference signal 3415 is then transmitted through a power-over-coax circuit and transmitted through cable 370c to the shared light emitter. Further in this example, LIDAR time reference signal generator 420 divides the clock signal 407 by a factor of 5 to generate the 8 Mhz detector time reference signal 417. It would be obvious to one of skill in the art that the 20 Mhz emitter reference signal can be recreated from the detector time reference signal at the LIDAR by knowing the ratio of the emitter and detector time reference signals and using a common clock signal to generate both reference signals. The LIDAR time reference signal generators can be part of an FPGA clock module such as the Clock wizard Logicore IP available for the Zynq FPGA family from Xilinx of San Jose Calif.

Ranging subassembly 400 further comprises a Deserializer Hub that functions to capture multiple serial streams of time of flight data from several LIDARs. An exemplary deserializer hub is the quad FPDLink hub ds90ub960 from Texas Instruments Inc. of Dallas Tex. The deserializer receives high speed data from the LIDARs and transmits commands (e.g. I2C commands to the LIDARs over a backchannel). In one aspect hub 430 can be commanded from a timing controller 440 to turn off the backchannel signal when the ranging subassembly wants to transmit the detector timing reference signal without interference. This requires closely coordinated timing of when the LIDAR is transmitting data but does enable a single coaxial cable 370a to carry power to the LIDAR, data from the LIDAR and carry the detector timing reference signal 417. Timing controller 440 can be a dedicated circuit comprising of transistor logic or can be software running on a microprocessor that times when deserializer is instructed to first tell the serializer in the LIDAR to depower and then turns off the backchannel to thereby free up the cable 370 for transmission of the detector time reference signal 417. The time signal combiner and switch 435 is circuitry that function to combine the detector time reference signal (e.g. 8 Mhz signal) and the serializer link (e.g. a 4.16 Ghz signal). Combiner 435 can comprise ferrite filters, inductors, capacitors, diodes and amplifiers for the purpose of combining the two signal paths. POC circuitry 425 functions to add power to the cable 370a to power the LIDAR. 3D Location calculator 450 and point cloud generator 460 process the time of flight signals from deserializer hub 430 to represent the 3D locations of light reflections from the shared emitter.

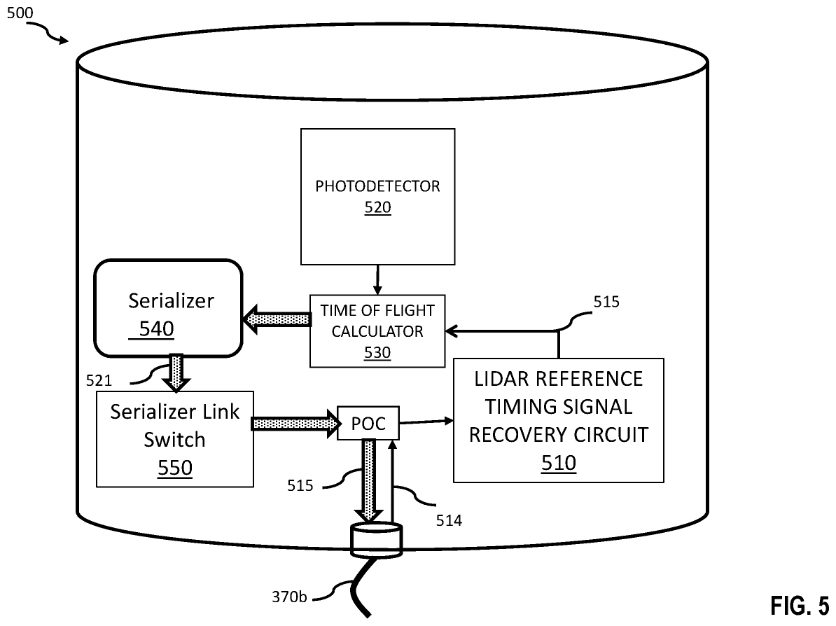

FIG. 5 illustrates an exemplary LIDAR 500 in accordance with an embodiment of the current disclosure. LIDAR 500 transmits sets of time of flight signals 515 to the ranging subassembly and receive detector time reference signals 514. The time reference signal 514 can be degraded due to cable losses and signal leakage into the serializer/deserializer. The signal can be recovered in the LIDAR reference timing signal recovery circuitry 510. This can include amplifiers and filters to identify and amplify the detector time reference signal from among the other signals on cable 370b. recovery circuitry 510 can also apply a known transfer function (e.g. multiple by 4) to the timing reference signal based on the system design for the purpose of establishing a TOF reference signal 515. LIDAR 500 further comprises a photodetector 520 to detect light reflections from one or more share light emitters. Photodetector 520 can be a single detector (e.g. a single photon avalanche detector SPAD) or a photodetector array (e.g. IMX459 SPAD array from Sony). The photodetector 520 transfer reflection signals to the time of flight calculator 530. Time of flight calculator can be a dedicated microchip such as the MLX75123 co-processor from Melexis in Ypres Belgium. The time of flight calculator 530 can also be a time to digital converter such as the TDC7200 from Texas Instruments of Dallas Tex. TOF reference signal 515 functions as a time reference for the time of flight calculator. The time of flight calculator functions to transmit a stream of time of flight measurements (base on the detector time reference signal) to the serializer. Serializer link switch 550 enables the ranging subassembly to switch off the serializer data stream 521 when the detector time reference signal is transmitted. This has the benefit of making the cable 370b quieter and hence increasing the accuracy of the detector time reference signal.

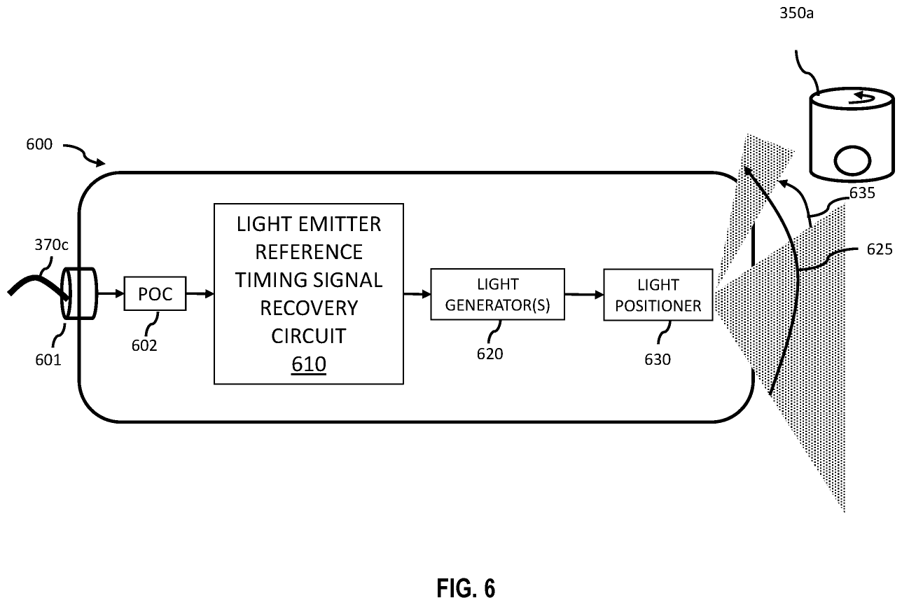

FIG. 6 illustrates a shared light emitter 600 in accordance with an embodiment of the present disclosure. Share emitter 600 functions to receive power and a emitter time reference signal via cable 370c at connector 601. The emitter time reference signal (i.e. the light emitter time reference signal) can be separated from the power signal by POC circuit 602. The light emitter reference timing signal can be recovered or buffered in signal recovery circuit 610. Signal recovery circuit 610 can comprise high speed buffers, amplifiers and current drivers such as UCC27517AQDBVRQ1 from Texas instruments of Dallas Tex. In the embodiment of FIG. 6 the recovered emitter reference signal or light emitter reference timing signal is input to one or more light generator(s) 620. Light generator(s) 620 could be a single laserthat generates laser pulses according to the voltage transitions of the light emitter reference timing signal. For example, the laser could produce a pulse every time the light emitter reference signal is above a threshold voltage (e.g. >0.7V). Light generators(s) 620 could be a line of lasers that are scanned through a FOV 625 by a light positioner 630 to generate a 2D scanning pattern in the field of view. Light generator(s) 620 could be an array of LEDs, or vertical cavity surface emitting lasers operable to emit light in a plurality of directions at once. Share light emitter 600 further comprises a light positioner 630 that functions to position or spread light from the light emitter in the FOV. Light positioner 620 could be a scanning mirror assembly that scans in 1 or 2 dimensions thereby directing light from light generator(s) 620 into a range of directions in a time multiplexed manner. One aspect of a multi-LIDAR system with shared emitters is that the emitters may be positioned in the FOV of the LIDARs. This may be problematic since a direct light pulse from the shared emitter directed towards a LIDAR may produce an undesirably large response at the photodetector. In the embodiment of FIG. 6 share light emitter 600 learns the present of LIDAR 350a in a portion of the FOV 625. Share light emitter 600 can deactivate or prevent light generator 620 from generating pulses when it is pointed towards LIDAR 350a. For example, light generator 620 can cease to produce light pulses in the portion 635 of the FOV 625. Emitter 600 may have a variety of placements on a vehicle that change throughout design and hence determining the portion 635 in the design process may be challenging. Instead LIDAR 350a can report to ranging subassembly 215 that it sees an undesirably large light intensity from shared light emitter 600 at a particular part of a scan pattern. The light scan pattern may be initiated or encoded into the emitter time reference signal. The ranging subassembly may instruct the shared light emitter to not produce light pulses during a portion of the scan pattern by modifying the emitter time reference signal. For example, the ranging subassembly could send an initial emitter time reference signal comprising a 20 Mhz 0-5V with a duration of 10 milliseconds. Subsequently a LIDAR may report seeing direct light pulses in a portion of its FOV and ranging subassembly may modify the emitter time reference signal to be 20 Mhz 0-5V for 7 milliseconds followed by a 0V or 1 millisecond (while light positioner 630 is scanning in a region 635 of the FOV 625), followed by 2 milliseconds where the reference signal returns to 20 Mhz 0-5V. In this way LIDARs can report regions of the FOV (or times) when they see direct light pulses from the shared emitters in a system. Light emitters can be subsequently reconfigured by modifying the emitter time reference signal. In other embodiments the shared light emitter can stop scanning in portion 636 of FOV 625. In still other embodiments ranging subassembly 215 can cut power to shared light emitter 600 for a period of time corresponding to the portion 635 of FOV 625 that would directly illuminate LIDAR 350a.

Operation

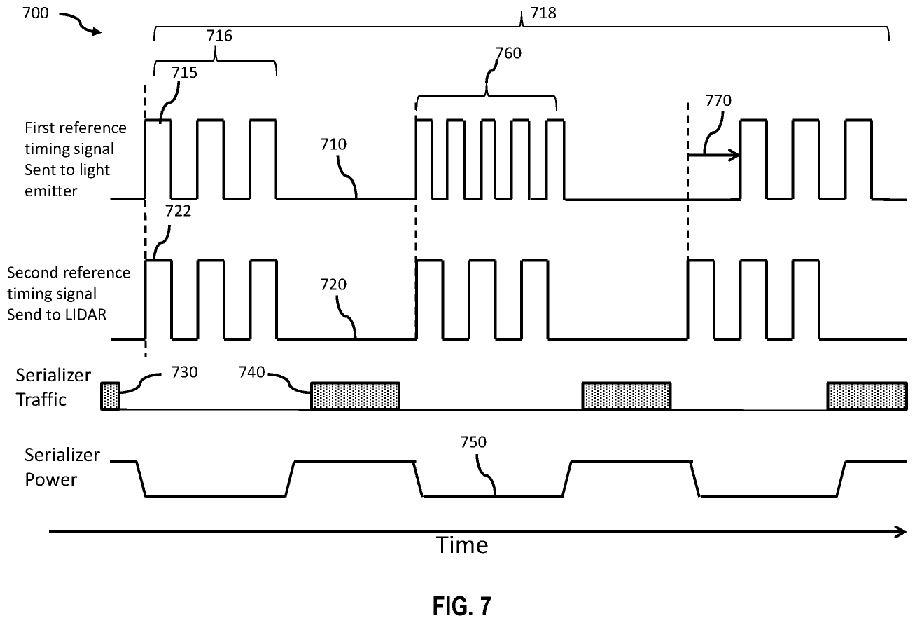

FIG. 7 illustrates an exemplary timing diagram 700 for a distributed perimeter LIDAR with shared light emitters. Timing diagram 700 is useful to explain the detailed operation of an exemplary embodiment of a distributed perimeter LIDAR with shared emitters. An emitter time reference signal 710 is transmitted to one or more shared light emitters. The emitter time reference signal has several pulses e.g. pulse 715. These pulses can form a continuous wave (e.g. a square wave). These pulses can be grouped into frames or phases e.g. phase 716. In a time-of-flight architecture camera it is common to create modulated light for several periods of time with a distinct phase in each period of time. Each period of time is referred to as a phase. Several phases form a frame. A frame is a group of phases sufficient to enable ranges to be calculated.

A detector time reference signal 720 is transmitted to one or more LIDARs. The function of the detector time reference signal is to enable the LIDAR to determine when received light reflections were generated. To this end, the detector time reference can have identical pulses (e.g. pulse 722) timing and duration to pulses in the emitter time reference signal. However in other embodiments the detector time reference signal need not be identical to the emitter time reference signal in order to still provide a time reference for when light pulses were produced. For example, a relationship or transfer function may exist between the emitter and detector time reference signals. The emitter time reference signal may be twice the frequency of the detector time reference signal, illustrated in region 760. The emitter time reference may have a time delay due to signal propagation as illustrated by time shift 770. Nevertheless the detector time reference signal can be used to, calculate the time of flight of light reflections from the shared emitters.

Serializer traffic is illustrated as packets 740 and frame start command 730. In one aspect many serializers keep the high speed data channel to the deserializer active even when not sending data. This serializer signal constitutes is a source of noise and hence time uncertainty for the detector time reference signal. To improve the quality of the detector time reference signal the ranging subassembly can instruct the LIDAR shut off serializer power 750 for a period time while the detector time reference signal is being transmitted (usually during the integration time of the TOF photodetector). One way to accomplish this is to transmit a first POC voltage level (e.g. VA=15V) from the ranging subassembly 215 during normal serializer operation. When the ranging subassembly wants the serializer at the LIDAR to power down during the transmission of the detector time reference signal the ranging subassembly can transmit a second POC voltage level VB (e.g. VB=8V). The serializer link switch circuit 550 in FIG. 5 can identify the transition from VA to VB and power down the transmitter in the serializer, creating a quiet co-axial cable 370b to transmit the precise detector time reference signal. For example, consider the MLX75026 time of flight chip from Melexis and the DS90UB953 serializer from Texas instruments. The ranging subassembly can instruct the LIDAR to depower the DS90UB953 using a power voltage change, the ranging subassembly can then transmit the detector time reference signal as a series of clock pulses that cause the MLX75026 to generate a DMIX signal to modulate the photodetector pixel array in accordance with the phase of the reflected light from a shared emitter that receives the emitter time reference signal 710. Once the phase is complete (e.g. phase 716) and the MLX75026 has data to transmit the power voltage signals to the LIDAR to power the DS90ub953 transmitter and send the data. Hence both the detector time reference signal and the TOF data can time share a common coaxial cable providing simplified integration.

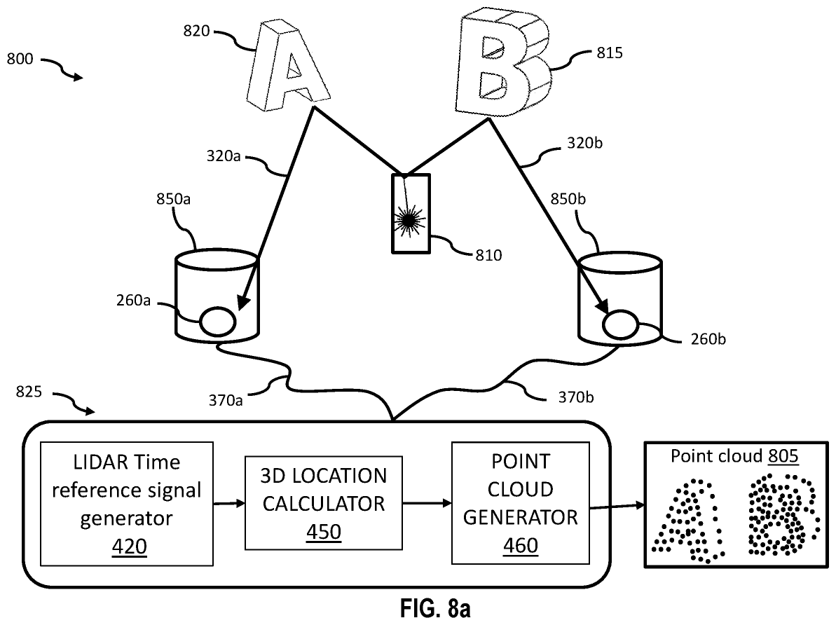

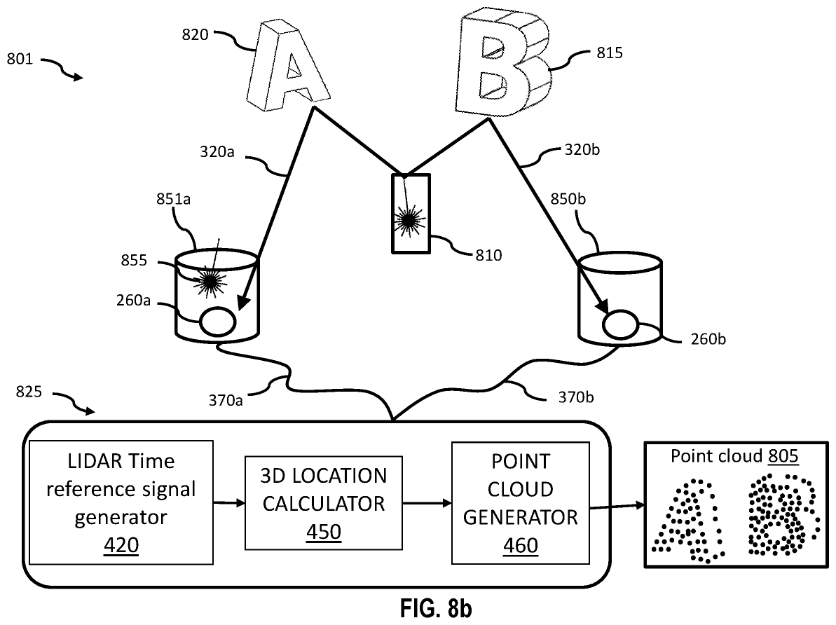

FIG. 8a illustrates a 3D location sensing system 800 that functions to generate a pointcloud 805, using a shared emitter 810 and two LIDARs that each process light reflections from the shared emitter). In the embodiment of FIG. 8a 3D location sensing system 800 comprises a first LIDAR) configured to process light reflections 320a and corresponding to light emitted by a shared emitter 810 and thereby generate first range data. The system 800 further comprises a second LIDAR, located separate from the first LIDAR by a portion of a host platform, and configured to process light reflections 320b corresponding to light emitted by the shared emitter 810 and thereby generate second range data. System 800 further comprises a ranging subassembly 825 with a 3D location calculator 450 configured to calculate a set of 3D locations, indicative of reflection locations of the light emitted by the shared emitter, by processing at least some of the first range data and at least some of the second range data. 3D pointcloud 805 can be a set of 3D locations relative to the host platform (e.g. a car) that represents the 3D coordinates of real world surfaces in the local environment (e.g. locations of surrounding vehicles).

3D location sensing system 800 can function to utilize a shared light emitter 810 between multiple LIDARs 850a and 850b. System 800 can solve two challenges to utilize the shared emitter, firstly determining the location of the shared emitter 810 relative to the LIDARs 850a and 850b and secondly to determine the timing when the shared emitter emits light.

System 800 can be mounted on a host platform. Exemplary host platforms include a vehicle, a building, a person, a bridge, a road sign, or a robot. Exemplary host vehicles include a ship, a car, a truck, a train, an airplane, a drone or a bicycle. Shared emitter 810 can be attached to the host platform in a location known to the ranging subassembly 825. In this case the location of the shared emitter relative to LIDARs 850a and 850b can be stored by 3D location sensing system 800.

Alternatively shared emitter 810 can be movable relative to the two LIDARs 850a and 850b. For example, the shared emitter could be located separate from the host platform (e.g. host platform=a car) and the shared emitter is located on a light pole at an intersection. In an embodiment where shared emitter 810 moves relative to the LIDARs 850a and 850b a challenge for the ranging subassembly 825 is to calculate the instantaneous position of the shared emitter 810. This can be accomplished by identifying a common object in the range data from the first LIDAR 850a and in the range data from the second LIDAR 850b. This common object could be the shared emitter 810, an object in the local environment (e.g. object “A” 820 or object “B” 815), or a part of the host platform (e.g. a fiducial mark on fender on a host car).

FIG. 8b illustrates a similar 3D location sensing system 801 in which LIDAR 851a comprises a dedicated light emitter 855. The position and timing of dedicated light emitter 855 can be fixed within LIDAR 851 and can thereby enable system 801 to utilize a shared emitter 810. For example, LIDAR 851 can perform range measurements of object 820 by emitting light from dedicated light emitter 855 and transmitting range data corresponding to the time of flight of the light pulses to the ranging subassembly 825. Subsequently shared emitter 810 can emit light and LIDAR 851 can transmit range data from the same portion of the FOV to the ranging subassembly. The ranging subassembly can determine the location and timing of shared light emitter 810 necessary to recreate the equivalent point cloud with both sets of range data. In a related embodiment, ranging subassembly 825 can send a timing reference signal to the shared emitter and to the LIDAR to synchronize them.

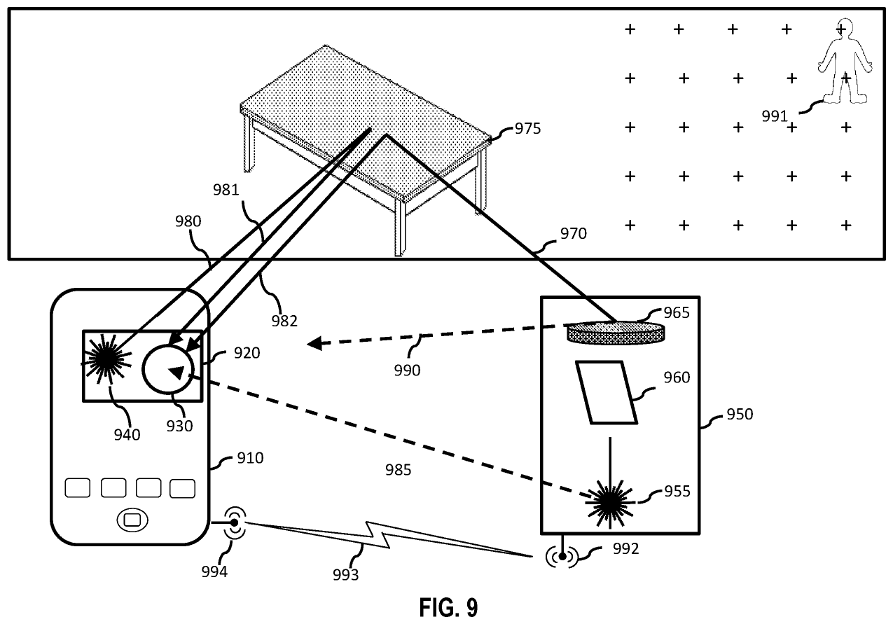

FIG. 9 illustrates an external light emitter apparatus 950 for providing laser light to a LIDAR in a separate LIDAR-host device (e.g. cellular phone 910). Recently, LIDARs have been added to cellular phones and tablet PCs (e.g. the iPhone 13 and iPad Pro both from Apple computers of Cupertino, Calif.). These cell phones and tablets have many components vying for space. This limits the space for the laser in the LIDAR and thereby limits the range and FOV of the LIDAR. FIG. 9 illustrates an apparatus 950 for externally generating laser pulses that are then used by the LIDAR in the consumer electronics (cellular phone, tablet, VR goggles etc.) This external light emitter (i.e. external illuminator) can be larger and more powerful than the laser or illuminator in the consumer electronics with the LIDAR. Two challenges with using such an external light emitter are (1) determining the location of the illuminator relative to the LIDAR (2) determining at the LIDAR when each of the external pulses were generated to enable time of flight of the light pulse to be determined. External light emitter 950 can be equipped with features (e.g. a wireless transmitter, an optical time reference generator or a wired reference signal generator) to solve these challenges.

Turning to FIG. 9 in detail, the LIDAR-host device is this embodiment is a cellular phone 910 comprising LIDAR 920. LIDAR 920 further comprises a light receiver 930 and internal light transmitter 940. Light receiver 930 can be a receiver array such as a SPAD array, a silicon photomultiplier (SiPM) array or a charge-coupled device (CCD) array. The internal light transmitter 940 can comprise one or more LEDs, lasers, vertical cavity surface emitting lasers (VSCELs), lenses, scanning mirrors and diffractive optical elements (DOEs). A limitation of light transmitter 940 is that it is housed in LIDAR-host device where it competes for space and power with all of the other components in the cellular phone. Hence several aspects of the internal light transmitter can be compromised to suit the LIDAR-host device such as the FOV, maximum pulse power, laser spot sizes and pulse rate. External light emitter 950 offers a great way to overcome the deficiencies of the internal LIDAR illuminator. External light emitter 950 can be dedicated to the task of generating light pulses for internal LIDAR 920. Alternatively external light emitter 950 can be shared among multiple LIDARs. In this was the external light emitter can be a shared light emitter such as shared emitter 810 in FIG. 8a or shared emitter 120b in FIG. 1. In this mode the external light emitter can share it's position and pulse timing with a plurality of LIDAR-host devices and thereby enable multiple LIDAR host devices to estimate the location of objects in the local environment from corresponding light reflections.

External light emitter 950 can comprise laser 955 to generate light pulses, scanning mirror 960 to scan the light pulses across a field of view and one or more lenses 965 to focus, collimate or spread the light pulses. In the embodiment of FIG. 9 the external light emitter has a wireless radio transmitter 992 operable to send timing signals 993 to a wireless receiver circuit 994 at the LIDAR host device. The wireless radio transmitter 992 can be configured to transmit timing data indicating the accurate timing of a light pulse from the external light emitter and thereby enable the LIDAR to use the timing signals 993 to determine the time of flight of the light pulses (e.g. light pulse 970). In an alternative embodiment, similar to FIG. 9 the LIDAR-host device 910 can transmit wireless radio signals to the external light emitter using a radio transmitter similar to transmitter 992. In this way a LIDAR-host device can transmit timing or trigger signals to the external light emitter that can be used by the external light emitter to determine when to create light pulses. The LIDAR 920 in the host device can assume or confirm that the external light emitter is generating pulses based on the timing signals and calculate the location (or distance) to reflection locations accordingly. In the embodiment of FIG. 9 light pulse 990 is a timing reference light pulse and has a direction from the external light emitter towards the light receiver 930 in LIDAR 920. Timing reference light pulse 990 serves a few important purposes. In order to effectively utilize an external LIDAR light emitter the LIDAR needs to understand the timing and location of the external light generator light pulses. Light receiver 930 can receive the timing reference light pulse and use the location within the light receiver (e.g. the incident pixel within the pixel array) to identify a direction of the external light emitter 950 within the field of view of the LIDAR 920. Once the direction of the external light emitter is known, another challenge is to identify the distance from the LIDAR to the external light emitter along this direction.

External Light Emitter Operation

In a first embodiment a LIDAR in a host device can utilize an external LIDAR pulse generator or illuminator using the following steps. Both an external and internal illuminator can generate light pulses that reflect to the light detector (i.e. light receiver) of the LIDAR and the location of external light emitter can be thereby characterized for computing the distance to subsequent objects illuminated by the external light emitter. The LIDAR 920 can generate one or more pulses of light (e.g. pulse 980). This light can reflect from a location (e.g. the center of table 975). The time of arrival of reflection 981 at receiver 930 can be used to determine the distance to the reflection location. Reflections from several directions can be used to generate a 3D image of table 975. External light emitter 950 can generate one or more pulses of light. These pulses can be short discrete pulses (e.g. 5-10 nanoseconds in duration) or these pulses can be a continuous wave of pulses with a pulse frequency (e.g. a pulse frequency of 20-100 Mhz). Receiver 930 can receive reflections (e.g. reflection 982) from light pulse 970. These reflections can be from substantially similar locations on table 975 as the reflections from the internal illuminator 940. Reflections (e.g. 982) from the external light emitter 950 can be used to generate a 3D image of table 975 at the LIDAR host device 910. LIDAR host device 910 can be configured to identify and compare a subset of reflection data from the internally generated light pulses and externally generated light pulses. In other embodiments a LIDAR host device could be a cellular telephone, virtual reality goggles, a tablet a video game console or a display device. The identification of the subset of light reflections corresponding to each illumination source may be based on objects that are well illuminated by each of the internal and external light emitters. The LIDAR host device can estimate a location and pointing direction of the external light emitter by processing the subset of reflections from the external light emitter. For example, both the external and internal illuminators may generate light reflections from the table 975. The LIDAR host device may use the internal reflections and associated timing as a source of truth for the location and distance of the table in a FOV of the LIDAR. The reflection data (e.g. reflection 982) from the external light emitter can be processed by the LIDAR host device to best map the reflections from the table onto the expected location (e.g. range of directions in the FOV) and the expected distance. This processing can generate an expected position and pointing direction of the external light emitter. The LIDAR host device can use the position and direction of the external light emitter to process other reflections from light generated by the external light emitter (e.g. reflections from person 991). These reflections may not have corresponding reflections from the internal illuminator. However, the location and direction of the external light emitter can enable these reflections to be located relative to the LIDAR 920. In this way, this method enables a calibration set of reflections from both an internal and external light emitter to calibrate or model the location and direction of an external light emitter relative to a LIDAR and provides a model for calculating 3D reflections corresponding to light reflections from light from the external light emitter.

In a second embodiment, LIDAR 920 can generate a trigger signal that is operable to instruct an external light emitter to generate one or more light pulses in a plurality of directions (e.g. one or more flashes in a field of view). The trigger signal can be a radio wave (e.g. wireless radio signal) or an optical signal. The external light emitter can generate a corresponding response signal (e.g. radio wave 993 or optical signal 985). The LIDAR host device can use a measure of the phase relationship or time difference between the outgoing trigger signal and response signal to estimate the distance of the external light emitter to the LIDAR host device. Optical signal 985 can be a light pulse or a periodic light signal (e.g. a 850 nm infrared light emitted with a 20 Mhz modulation frequency). The Optical signal 985 can be part of one or more light pulses generated by the external light emitter 950 for ranging objects. Optical signal 985 can travel directly from the external light emitter to the LIDAR and can function to indicate to LIDAR 920 a location of the external light emitter 950 in the FOV of the LIDAR 920. For example, LIDAR 920 may receive a strong infrared signal at one or more pixels in a light detector array in light receiver 930 indicating the presence of an external light emitter 950 in a corresponding portion of the FOV. Optical signal 985 can be phase locked to a timing or trigger signal from the LIDAR or LIDAR host device (e.g. a 20 Mhz radio signal). This phase relationship between an optical signal 985 and a trigger signal from the LIDAR or LIDAR host device can be used by the LIDAR host device to estimate the distance of the external light emitter along the direction provided by the optical signal 985. In this way the optical signal can provide both a direction and distance (which combined can form a location) of the external light emitter relative to the LIDAR.

In a related embodiment external light emitter 950 can be configured to transmit a radio signal 993 when it transmits a light pulse (e.g. pulse 970). This radio signal 993 can be used by the LIDAR or LIDAR host device to identify when the light emitter has generated a light pulse.

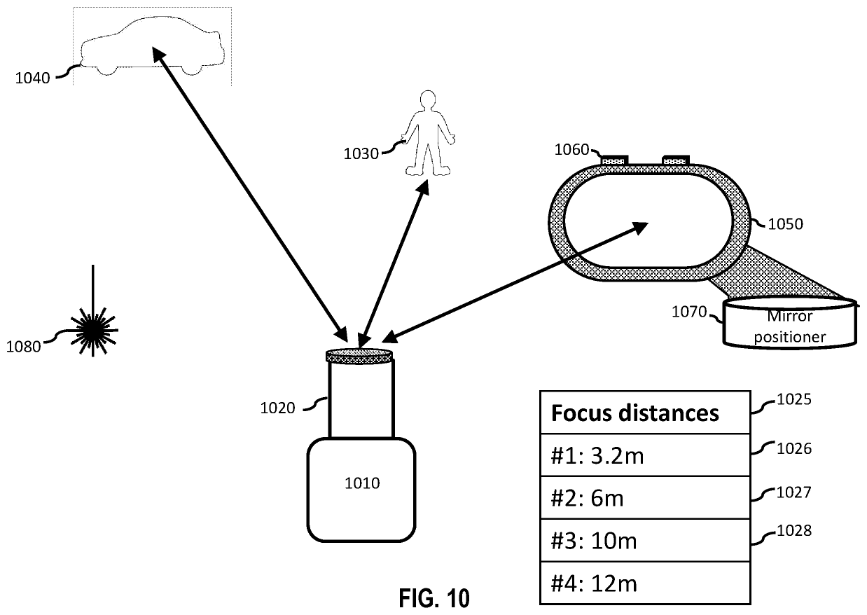

FIG. 10 illustrates a related invention. Camera 1010 can comprise a focusable lens assembly 1020. Exemplary focusable lens assemblies include those found in smartphones and DSLR cameras. Today many cameras used in autonomous vehicles (AV) are fixed focus cameras. It would be beneficial to focus a camera on an AV at individual targets (e.g. person 1030 and car 1040) to provide a clearer image of these targets. One of the reasons for using fixed focus cameras in autonomous vehicles is that autofocus techniques require time to focus the camera lens. For example, an autofocus technique can tune the lens focus over the course of several images by optimizing for image contrast to provide a sharp image of a selected object. However this iterative process takes ˜1 second. The system of FIG. 10 provides a solution to this problem. Camera 1010 receives a sequence or list of focus positions 1025 corresponding to objects of interest in the local environment. This list can be generated and updated based on process previous images from camera 1010 or by processing data from other sensors such as a LIDAR or a RADAR.

In one aspect the list of focus positions can be ordered to enable the focusable lens assembly 1020 to more easily step from one focus position to another. For example, in list 1025, the focus distances are ordered from nearest to furthest from the camera. In one embodiment a sensor data processor can identify person 1030 as an object of interest and iteratively update a focus position 1026 to best focus on person 1030 while stepping through the sequence 1025 of focus positions. Similarly focus position 1028 can be selected based on identifying a vehicle 1040 with sensor data. In one embodiment a sensor data process processes sensor data (e.g. camera, LIDAR or RADAR data) and thereby updates a sequence 1025 of focus positions. Camera 1010 modifies the focusable lens assembly 1020 to focus on each of the focus positions in sequence 1025 in order. For each focus position camera 1010 gathers one or more images. In one embodiment camera 1010 can gather data from a specific region of interest (i.e. a ROI containing the object being focused on). One of the focus distances 1028 can be a remote mirror 1050 that is operable to provide a remote FOV to camera 1010 (e.g. a side view mirror operable to show camera 1010 objects outside the FOV of camera 1010). Remote mirror 1028 can have features 1060 operable to identify remote mirror 1050 as a remote mirror. Features 1060 can be reflectors, beacons, or features with a distinctive shape. Remote mirror 1050 may also have a remote mirror positioner operable to receive messages and to alter the position of remote mirror 1050 based on these messages. Remote mirror 1050 can have a relatively constant focus distance 1028 from camera 1010. In this way Focus distance list 1025 can comprise some focus distances that change as objects (e.g. person 1030 move in the FOV) and some objects (e.g. remote mirror 1050) that are stationary or fixed in position. The sensor data processor can be configured to process data from movable objects to update their focus position while not updating the focus position corresponding to the remote mirror 1050. The camera 1010 can step through the combined list of fixed and variable focus positions in order to provide the sharpest focus on each of a plurality of objects.

In one advantage focusing the camera accurately on the remote mirror provides a much more usable remote FOV from the remote mirror. In another embodiment LIDAR data is processed to identify the list of focus distances 1025 can the camera 1010 is stepped through these focus distances in a defined order (e.g. from furthest to nearest or from nearest to furthest). Similarly each of the focus distances can be assigned an importance (e.g. a score between 0 and 100). Camera 1010 can step through the focus distances in list 1025 in order of importance (e.g. from highest importance score to lowest). The sensor data processor can calculate a relative velocity and/or trajectory for one or more targets in the field of view and modify one, some or all of the focus distances to match the expected location of one or more of the objects during subsequent image capture by camera 1010. For example, camera 1010 may be mounted to an AV travelling at 10 meters per second towards a stationary person 1030 and a car travelling at 15 meters per second. The sensor data processor can calculate subsequent sequences of focus distances based on the respective relative speeds of the person 1030 and vehicle 1040 while not changing the focus distance of a remote mirror 1050 mounted to the AV. In another embodiment camera 1010 can be controllable to point in different directions. Each focus distance in the sequence of focus distances can also include a pointing direction (e.g. focus distance 1026 associated with person 1030 can have an associated pointing direction towards person 1030). The sequence of focus directions can further serve to steer the camera to the corresponding pointing direction.

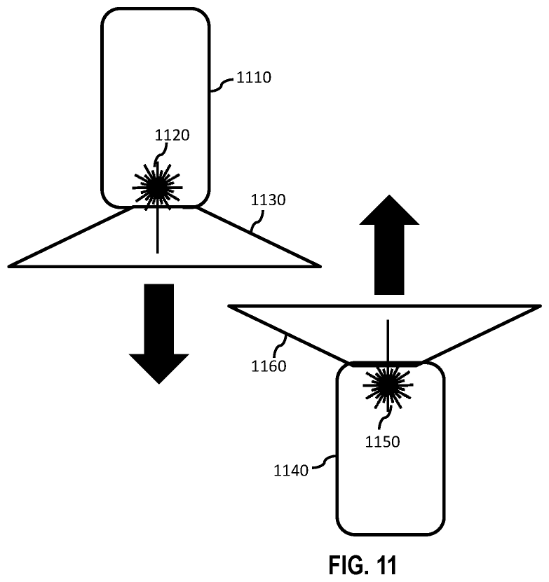

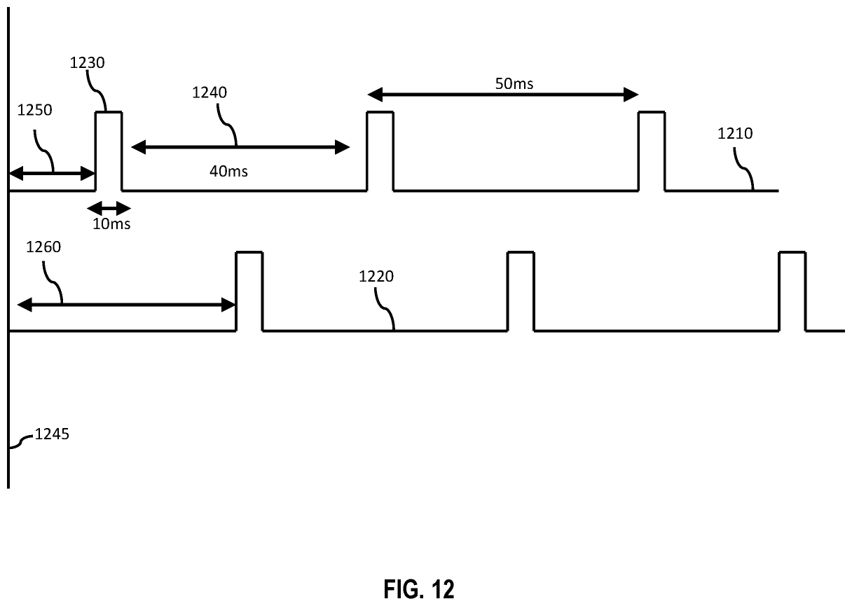

In another invention, a flash LIDAR can illuminate a FOV in a periodic manner with an offset to the periodicity that is determined at least in part by the direction that the LIDAR is pointing. Scanning LIDARS scan a laser through a field of view and the probability of shining the laser at another LIDAR is low due to the scanning motion. However a flash LIDAR illuminated a plurality of directions at once. This increases the potential for a flash LIDAR to interfere with another LIDAR in the local environment. One way to address this challenge is illustrated in FIG. 11 and FIG. 12. In FIG. 11 vehicle 1110 is travelling southbound and contains flash LIDAR 1120 that periodically illuminated FOV 1130. Similarly, vehicle 1140 is travelling northbound and contains flash LIDAR 1150 and is periodically illuminating FOV 1160. If LIDARS 1120 and 1150 flash their FOVS simultaneously there may be significant interference as each LIDAR will sense the other LIDARS laser flashing. One way to address this is shown in FIG. 12. where LIDAR 1150 flashes the FOV 1160 with the same periodicity as LIDAR 1120 but is configured to apply a phase offset (e.g. a time advance or time delay) to the periodicity of the laser flashes and wherein the offset is based on the direction the LIDAR is pointing. For example, waveform 1210 in FIG. 12 represents the illumination intensity of the laser in LIDAR 1120. The LIDAR flashes the FOV 1130 every 50 ms for a duration of 10 ms. This flash of 5 ms may comprise several shorter duration flashes (e.g. the 10 mS illumination time at 1230 may be further divided into 1 million pulses of duration 5 nanoseconds with the laser turned on and 5 ns with the laser turned off). In the example of FIG. 12 The remaining 40 ms of each period illustrated by 1240 the laser in LIDAR 1120 is not illuminating the FOV 1130. The flash timing of LIDAR 1120 can be relative to a time origin 1245. The flash can have a periodicity of 20 times per second (i.e. a 50 ms periodicity) and have a time offset 1250 relative to time origin 1245.

In one aspect this time offset can be based on the direction that LIDAR 1120 is pointing. In the example of FIG. 11 LIDAR 1120 is travelling southbound and the time offset 1250 can be based on this direction. Similarly LIDAR 1150 can have illumination timing illustrated by waveform 1220 with a different time offset 1260 (e.g. OFFSET=75 ms), wherein the time offset is based at least in part on LIDAR 1150 travelling northbound. FIG. 12 illustrated that waveforms 1210 and 1220 do not illuminate simultaneously and hence LIDARS 1120 and 1150 do not interfere with one another. In another similar invention a LIDAR 1120 and 1150 in FIG. 11 could instead be RADARs that transmit high frequency radio wave electromagnetic (EM) pulses. Similar to the embodiment of FIG. 11 the RADARS could generate EM pulses periodically and the pulses could have a time offset that is based at lease in part on the direction the RADAR is pointing. The time offset based on direction of the RADAR can function to avoid having emitted EM pulses from a first RADAR interfere with a second RADAR travelling in a substantially opposite direction.

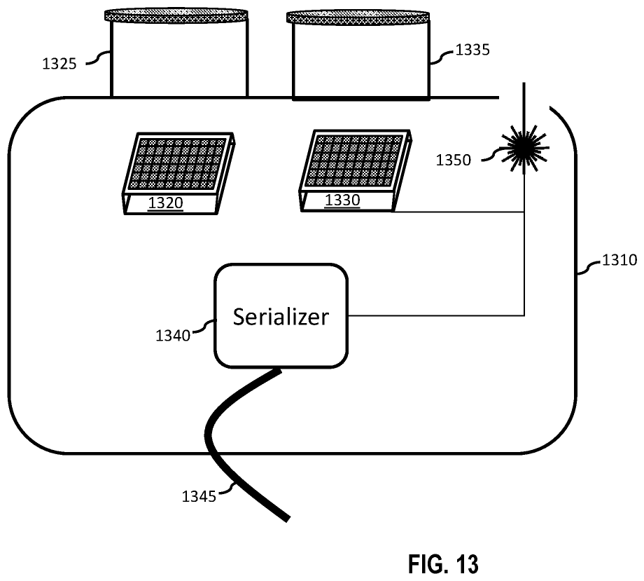

FIG. 13 illustrates a related invention wherein a camera and a LIDAR are co-located in a common enclosure. Apparatus 1310 is a combined camera LIDAR. In one aspect apparatus 1310 comprises a camera optical receiver chip 1320 (e.g. a CCD array such as IMX290 from Sony Corp.) and receiver array 1330 for a LIDAR (e.g. SPAD Array IMX459 from Sony Corp.). In another aspect apparatus 1310 can have a shared serializer 1340 is configured to be time shared between the camera receiver and the LIDAR receiver. For example, the serializer can be configured to trigger the camera receiver array 1320 and trigger the LIDAR receiver 1330 in a sequence and with a timing that ensures data from both the camera and LIDAR portions can be transmitted by the receiver over a common cable 1345. In one aspect LIDAR receiver 1330 or a separate LIDAR controller chip can be operable coupled to command an illuminator 1350 (e.g. a LASER a VSCEL or an LED) to generate light with very precise timing in order to be able to determine the time of flight of the light. For example, an IMX459 chip can be coupled to a VSCEL array. This light is also useful for illuminating the local environment for the camera. One challenge is synchronizing the pulses of light with the camera integration time window (i.e. the period of time after the camera receiver chip is triggered when photons can be captured at the receiver ship). In one aspect the serializer can be configured or commanded to trigger the camera at a time relative triggering of the LIDAR that functions to ensure the LIDAR commands illuminator 1350 to emit light when camera receiver is sensing photons. In a related embodiment the LIDAR periodically controls the illuminator 1350 and the camera simultaneously periodically the illuminator. This enables the LIDAR to emit precisely timed light pulses using the illuminator, while also enabling the camera to flash the local environment with light using the illuminator to capture a camera image (e.g. during night driving). In a related embodiment the camera and LIDAR portions of apparatus 1310 can control the illuminator in a periodic manner with each having the same periodicity (e.g. 10 flashes per second) but a different time offset. For example, the LIDAR can command the illuminator 1350 to generate a 5 millisecond flash every 100 milliseconds(i.e. a periodicity of 100 milliseconds). While the LIDAR is periodically controlling the illuminator the camera can also command the illuminator 1350 to generate a 10 millisecond pulse every 100 milliseconds (i.e. with the same periodicity, but not necessarily the same pulse duration). The 5 millisecond illumination pulse from the LIDAR and the 10 millisecond pulse from the camera can be offset in time to avoid conflicting commands to the illuminator.

In a related embodiment the serializer can be configured to generate the commands to the illuminator for either the camera operation, the LIDAR operation or both the camera and LIDAR operation. In a related embodiment the serializer generates a trigger signal for the camera receiver and a trigger signal for the LIDAR signal that are timed relative one another that a trigger signal to the illuminator 1350 can provide light photons while the LIDAR receiver is receptive and while the camera receiver is receptive to sensing photons from the illuminator. In one embodiment the trigger signals to the camera, LIDAR and illuminator can be simultaneous. One of the camera receiver chip or LIDAR receiver chip can be configured to delay transmitting sensor data for a period of time long enough to enable the other chip (i.e. the other camera or LIDAR chip) to firstly transmit sensor data to the serializer. For example, both the camera chip and the LIDAR receiver may be simultaneously along with the illuminator. The camera can acquire photons for 10 ms and then delay 50 ms before transmitting the image data via a CSI-2 link to the serializer in order to allow time for the LIDAR receiver to first transmit depth data to the serializer via the CSI-2 bus. Hence a camera and a LIDAR can use a common illuminator and a common serializer, allowing a smaller package and lower cost.

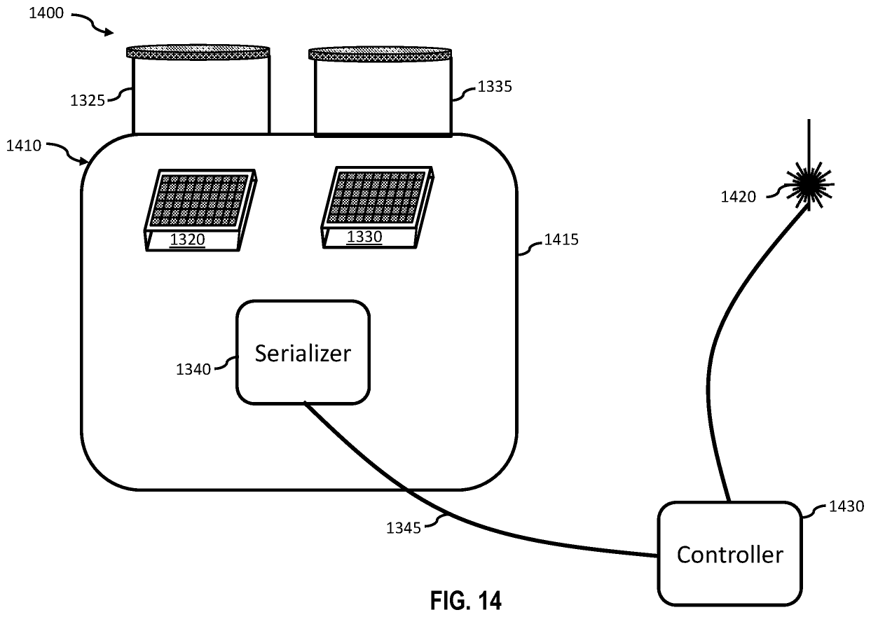

FIG. 14 illustrates a related system 1400 in which an apparatus 1410 comprises a camera and a LIDAR receiver. A shared illuminator 1320 is separate from the common enclosure 1415 of the camera and LIDAR receiver. The shared illuminator functions to provide precisely timed light pulses for the LIDAR receiver and to provide the same or different light pulses to the camera receiver. A controller 1430 separate from the common enclosure 1415 and the shared illuminator can provide trigger signals (i.e. timing signals) to apparatus 1410 as well as timing signals to the shared illuminator 1420. In one embodiment of this system 1400, shared illuminator 1420 can be housed in a headlight assembly of a vehicle while apparatus 1410 is housed partially behind a body panel of the vehicle with only the lenses 1325 and 1335 protruding through openings. External shared illuminator 1420 can function to provide timed illumination to one or more instances of apparatus 1410.

While the above description contains many specificities, these should not be construed as limitations on the scope of any embodiment, but as exemplifications of various embodiments thereof. Many other ramifications and variations are possible within the teachings of the various embodiments. Thus the scope should be determined by the appended claims and their legal equivalents, and not by the examples given.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A 3-dimensional (3D) location sensing system comprising:
a first light detection and ranging sensor (LIDAR) configured to process light reflections corresponding to light emitted by a shared emitter and thereby generate first range data;
a second LIDAR, located separate from the first LIDAR by a portion of a vehicle, and configured to process light reflections corresponding to light emitted by the shared emitter and thereby generate second range data; and
a ranging subassembly configured to calculate a set of 3D locations, indicative of reflection locations of the light emitted by the shared emitter, by processing at least some of the first range data and at least some of the second range data.
